(19) United States
(12) Patent Application Publication
(10) Pub. No.: US 2015/0370400 A1
(43) Pub. Date: Dec. 24, 2015

(54) LIGHT GUIDE DEVICE HAVING TOUCH FUNCTION

(71) Applicant: YICHENG PRECISION INC., Tainan City (TW)

(72) Inventors: Han-Chang CHEN, Taipei City (TW); Yen-Hung TU, Taipei City (TW); Chung-Lin CHIA, Taipei City (TW); Chih-Wen WU, Taipei City (TW); Jen-Chieh CHANG, Taipei City (TW)

(21) Appl. No.: 14/724,771

(22) Filed: May 28, 2015

(30) Foreign Application Priority Data
Jun. 18, 2014 (TW) 103121054

(51) Int. Cl. G06F 3/041; G06F 1/16; F21V 8/00; G06F 3/044

(52) U.S. Cl. CPC G06F 3/0416; G06F 3/044; G06F 1/16; G02B 6/0011; G06F 2203/04106

(57) ABSTRACT

A light guide device having touch function, including: a reflective plate having one or more conductive areas; a light source unit having a light output side; a light guide plate, located above the reflective plate and having a light input side and a light output face, wherein the light input side is adjacent to the light output side of the light source unit; and a control circuit having a touch detection unit, wherein, the touch detection unit is coupled with the one or more conductive areas of the reflective plate for detecting a touch event on the light output face.

### BACKGROUND OF THE INVENTION

1. Field of the Invention

The present invention relates to a light source device, especially to a light guide device having a touch function.

2. Description of the Related Art

Please refer to FIG. 1, which illustrates a touch-operable light source device of prior art. As illustrated in FIG. 1, the touch-operable light source device mainly includes a printed circuit board 10, a round shaped copper layer 20, a light emitting diode 30, and a transparent cover 40, wherein the round shaped copper layer 20 serves as a touch sensing electrode for generating a touch signal in response to a touch operation on the transparent cover 40.

However, as the touch-operable light source device of prior art uses the top surface of the transparent cover 40 as a touch surface, the output light of the touch-operable light source device cannot be made more uniform in intensity after passing through the transparent cover 40. Besides, the implementation of the round shaped copper layer 20 not only increases the cost, but severely reduces the routing space of the printed circuit board 10.

To solve the foregoing problems, a novel touch-operable light source device is needed.

### SUMMARY OF THE INVENTION

One objective of the present invention is to disclose a touch-operable light source device, which is capable of providing a touch-operable light source by utilizing a light guide structure.

Another objective of the present invention is to disclose a touch-operable light source device, which is capable of directly using a surface of a light guide structure as a touch surface, without the need of using an additional touch module.

Another objective of the present invention is to disclose a touch-operable light source device, which is capable of providing separate touch-operable light sources in separate regions of a light guide structure respectively.

Still another objective of the present invention is to disclose a touch-operable light source device, which is capable of providing separate touch-operable light sources in separate regions of predetermined shapes of a light guide structure respectively.

To attain the foregoing objectives, a light guide device having touch function is proposed, including:
a reflective plate having one or more conductive areas;
a light source unit having a light output side;
a light guide plate, located above the reflective plate and having a light input side and a light output face, wherein the light input side is adjacent to the light output side of the light source unit; and
a control circuit having a touch detection unit, wherein, the touch detection unit is coupled with the one or more conductive areas of the reflective plate for detecting a touch event on the light output face.

In one embodiment, the control circuit further includes a light source driver circuit coupled with the light source unit.

In one embodiment, the control circuit further includes a microprocessor coupled with the light source driver circuit and the touch detection unit for outputting a control signal to the light source driver circuit to control a light emitting status of the light source unit in response to a touch detection result from the touch detection unit.

In one embodiment, the touch detection unit detects the touch event by performing a capacitive touch detection procedure selected from a group consisting of a self-capacitive touch detection procedure and a mutual-capacitive touch detection procedure.

In one embodiment, the light output face of the light guide plate has an embossed figure.

In one embodiment, the light guide device having touch function further includes a liquid crystal layer above the light guide plate.

In one embodiment, the light guide device having touch function further includes a photo sensing unit.

To attain the foregoing objectives, another light guide device having touch function is proposed, including:
a reflective plate having one or more conductive areas;
a first light source unit having a first color of light and a first light output side;
a second light source unit having a second color of light and a second light output side;
a light guide plate, located above the reflective plate and having a first light input side, a second light input side, and a light output face, wherein the first light input side is adjacent to the first light output side of the first light source unit and the second light input side is adjacent to the second light output side of the second light source unit; and
a control circuit having a touch detection unit, wherein, the touch detection unit is coupled with the one or more conductive areas of the reflective plate for detecting a touch event on the light output face.

In one embodiment, the control circuit further includes a light source driver circuit and a microprocessor, the light source driver circuit being coupled with the first light source unit and the second light source unit, and the microprocessor being coupled with the light source driver circuit and the touch detection unit for outputting a control signal to the light source driver circuit to control a light emitting status of the first light source unit and/or a light emitting status of the second light source unit in response to a touch detection result from the touch detection unit.

To attain the foregoing objectives, still another light guide device having touch function is proposed, including:
a plurality of reflective plates, each having one or more conductive areas;
a plurality of light source units, each corresponding to one of the plurality of reflective plates and having a light output side;
a light guide plate, located above the plurality of reflective plates and having a plurality of light input zones and a light output face, wherein each of the plurality of light input zones is adjacent to the light output side of one of the plurality of light source units; and
a touch detection unit coupled with the one or more conductive areas of the plurality of reflective plates for detecting a location of a touch event on the light output face.

In one embodiment, the light guide plate has a disk shape.

In one embodiment, the light guide plate further has a plurality of slots dividing the light output face into a plurality of light output zones.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates a touch-operable light source device of prior art.

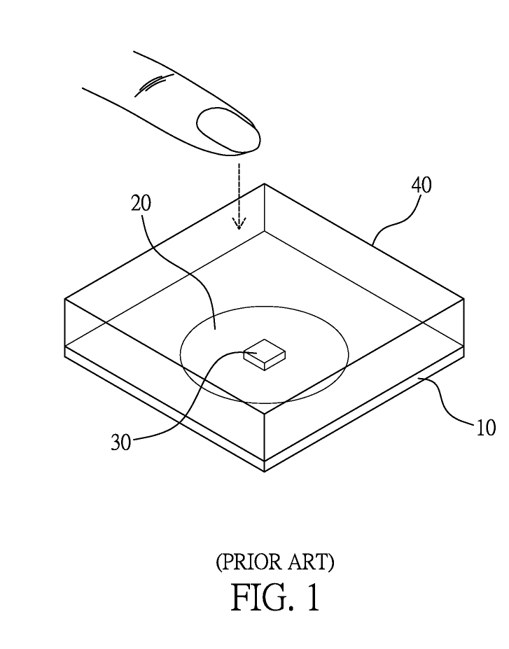

FIG. 2 illustrates an exploded view of a light guide device having touch function according to a preferred embodiment of the present invention.

FIG. 3 illustrates an assembly view of a light guide device having touch function according to another preferred embodiment of the present invention.

FIG. 4 illustrates an assembly view of a light guide device having touch function according to another preferred embodiment of the present invention.

FIG. 5 illustrates an exploded view of a light guide device having touch function according to another preferred embodiment of the present invention.

FIG. 6 illustrates an exploded view of a light guide device having touch function according to another preferred embodiment of the present invention.

FIG. 7 illustrates an exploded view of a light guide device having touch function according to another preferred embodiment of the present invention.

FIG. 8 illustrates an exploded view of a light guide device having touch function according to another preferred embodiment of the present invention.

FIG. 9 is an illustrative view of an embodiment of the light guide plate of the light guide device having touch function of the present invention.

FIG. 10 is an illustrative view of another embodiment of the light guide plate of the light guide device having touch function of the present invention.

### DETAILED DESCRIPTION OF THE PREFERRED EMBODIMENTS

The present invention will be described in more detail hereinafter with reference to the accompanying drawings that show the preferred embodiments of the invention.

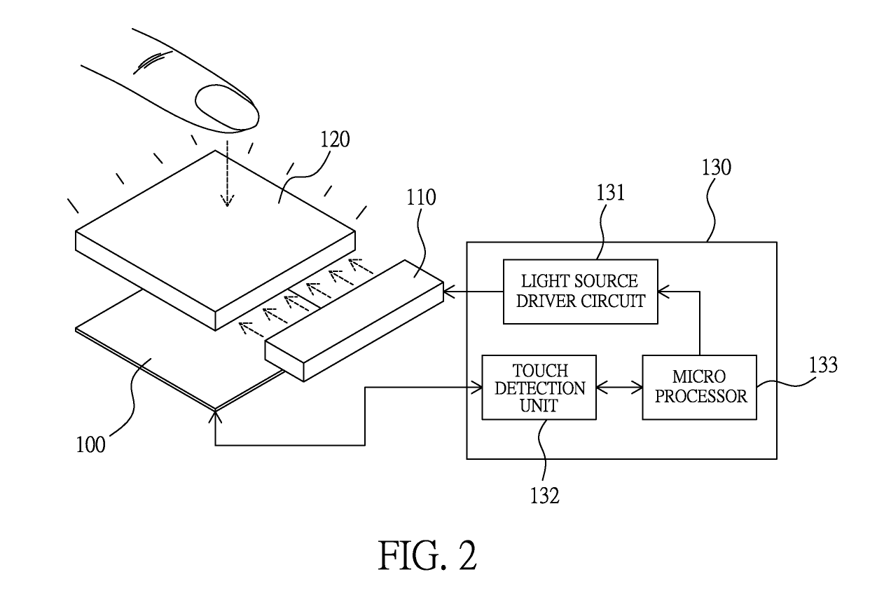

Please refer to FIG. 2, which illustrates an exploded view of a light guide device having touch function according to a preferred embodiment of the present invention. As illustrated in FIG. 2, the light guide device having touch function includes a reflective plate 100, a light source unit 110, a light guide plate 120, and a control circuit 130.

The reflective plate 100 has one or more conductive areas, which can be implemented by aluminum, stainless steel, PET (polyethylene terephthalate) coated with a conductive glue, etc.

The light source unit 110 can include at least one LED (light emitting diode) and has a light output side.

The light guide plate 120 is located above the reflective plate 100 and has a light input side and a light output face, wherein the light input side is adjacent to the light output side of the light source unit 110, and the light output face is used to output light and serves as a touch surface.

The control circuit 130 includes a light source driver circuit 131, a touch detection unit 132, and a microprocessor 133, wherein, the light source driver circuit 131 is coupled electrically with the light source unit 110; the touch detection unit 132 is coupled with the one or more conductive areas of the reflective plate 100 for detecting a touch event on the light output face; and the microprocessor 133 is coupled with the light source driver circuit 131 and the touch detection unit 132 for outputting a control signal to the light source driver circuit 131 to control a light emitting status of the light source unit 110 in response to a touch detection result from the touch detection unit 132.

The touch detection unit 132 detects the touch event by performing a capacitive touch detection procedure selected from a group consisting of a self-capacitive touch detection procedure and a mutual-capacitive touch detection procedure.

When a touch operation is detected, the light emitting status of the light source unit 110 can be readily changed by the control circuit 130.

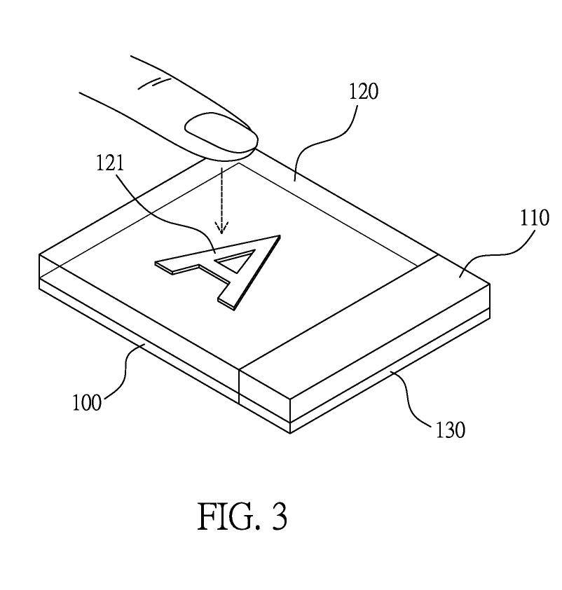

Please refer to FIG. 3, which illustrates an assembly view of a light guide device having touch function according to another preferred embodiment of the present invention. As illustrated in FIG. 3, the light guide plate 120 thereof has an embossed FIG. 121 on a light output face.

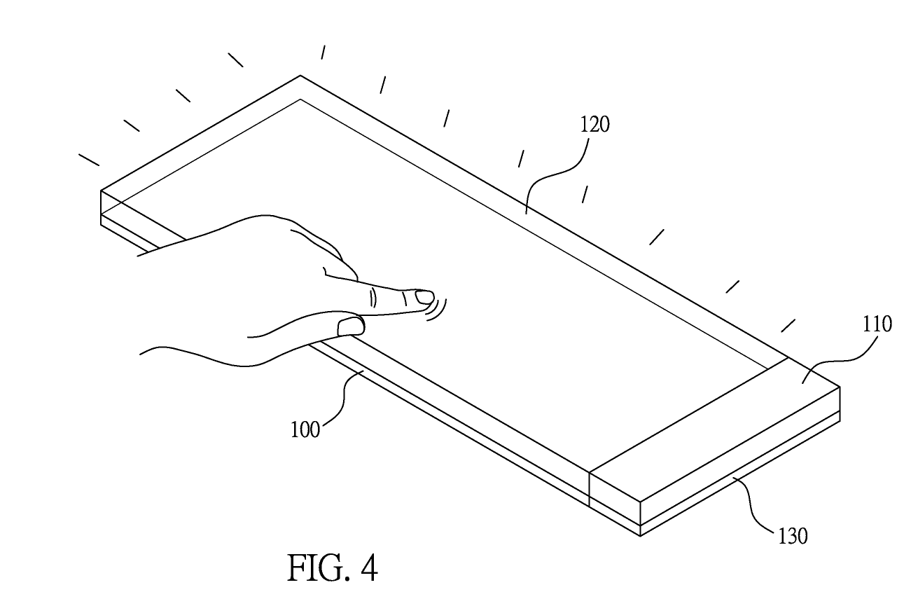

Please refer to FIG. 4, which illustrates an assembly view of a light guide device having touch function according to another preferred embodiment of the present invention. As illustrated in FIG. 4, the light guide device having touch function is used as a lighting device, and the lighting device can be switched on or off by touching a light output face thereof.

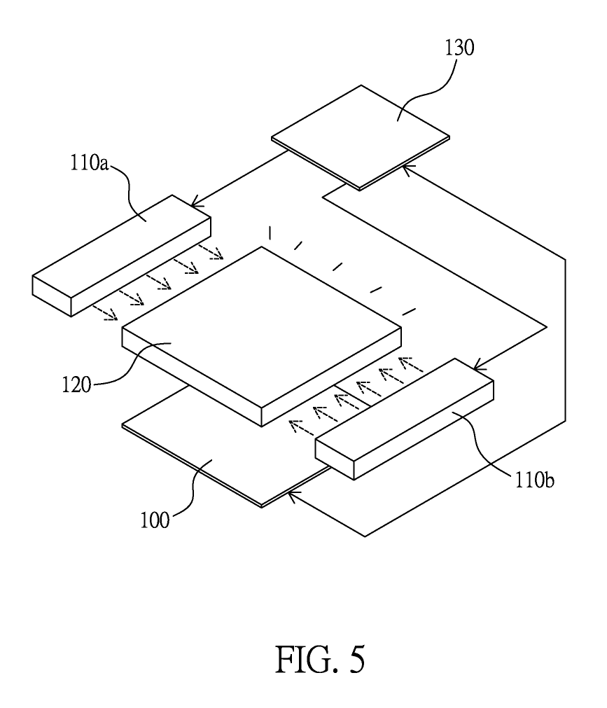

Please refer to FIG. 5, which illustrates an exploded view of a light guide device having touch function according to another preferred embodiment of the present invention. As illustrated in FIG. 5, the light guide device having touch function includes a reflective plate 100, a first light source unit 110a, a second light source unit 110b, a light guide plate 120, and a control circuit 130.

The reflective plate 100 has one or more conductive areas, which can be implemented by aluminum, stainless steel, PET coated with a conductive glue, etc.

The first light source unit 110a has a first color of light and a first light output side.

The second light source unit 110b has a second color of light and a second light output side.

The light guide plate 120 is located above the reflective plate 100 and has a first light input side, a second light input side, and a light output face, wherein the first light input side is adjacent to the first light output side of the first light source unit 110a and the second light input side is adjacent to the second light output side of the second light source unit 110b, and the light output face is used to output light and also serves as a touch surface.

The control circuit 130 has a touch detection unit, a light source driver circuit, and a microprocessor (not shown in the figure), wherein, the touch detection unit is coupled with the one or more conductive areas of the reflective plate 100, and detects a touch event on the light output face by performing a capacitive touch detection procedure, which is selected from a group consisting of a self-capacitive touch detection procedure and a mutual-capacitive touch detection procedure; the light source driver circuit is coupled with the first light source unit and the second light source unit, and the microprocessor is coupled with the light source driver circuit and the touch detection unit for outputting a control signal to the light source driver circuit to control a light emitting status of the first light source unit 110a and/or a light emitting status of the second light source unit 110b in response to a touch detection result from the touch detection unit. For example, the microprocessor can control the brightness of the first light source unit 110a and the brightness of the second light source unit 110b to provide different colors of resultant light according to different touch counts.

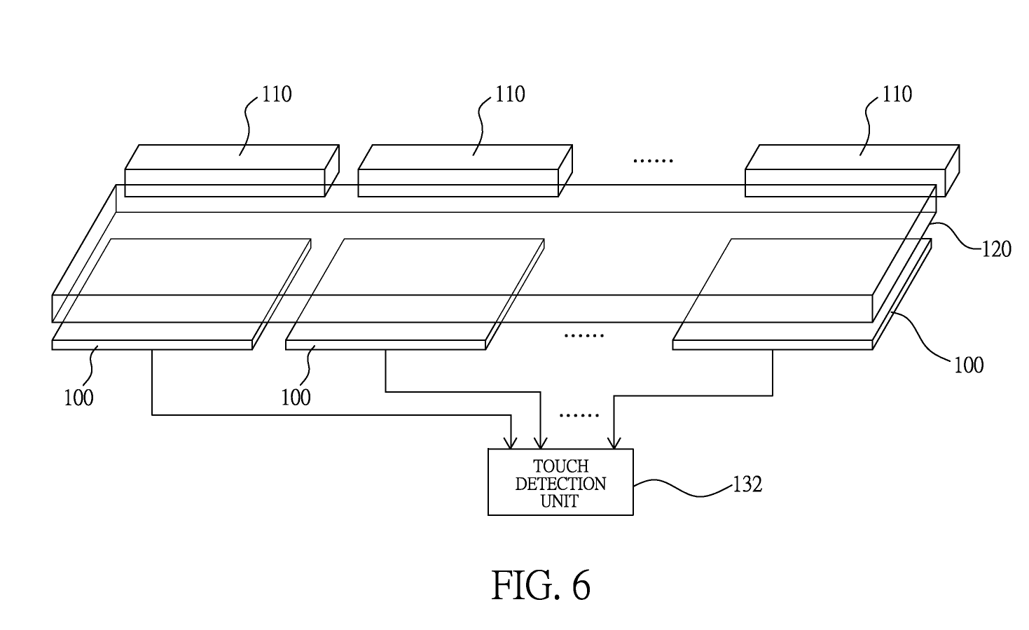

Please refer to FIG. 6, which illustrates an exploded view of a light guide device having touch function according to another preferred embodiment of the present invention. As illustrated in FIG. 6, the light guide device having touch function includes a plurality of reflective plates 100, a plurality of light source units 110, a light guide plate 120, and a touch detection unit 132.

Each of the plurality of reflective plates 100 has one or more conductive areas, which can be implemented by aluminum, stainless steel, PET coated with a conductive glue, etc.

Each of the plurality of light source units 110 corresponds to one of the plurality of reflective plates 100 and has a light output side.

The light guide plate 120 is located above the plurality of reflective plates 100 and has a plurality of light input zones and a light output face, wherein each of the plurality of light input zones is adjacent to the light output side of one of the plurality of light source units 110.

The touch detection unit 132 is coupled electrically with the one or more conductive areas of the plurality of reflective plates 100 for detecting a location of a touch event on the light output face.

Besides, although the light guide plate 120 shown in FIG. 6 is of a rectangular shape, it can also be of a disk shape or other shapes, depending on practical requirements.

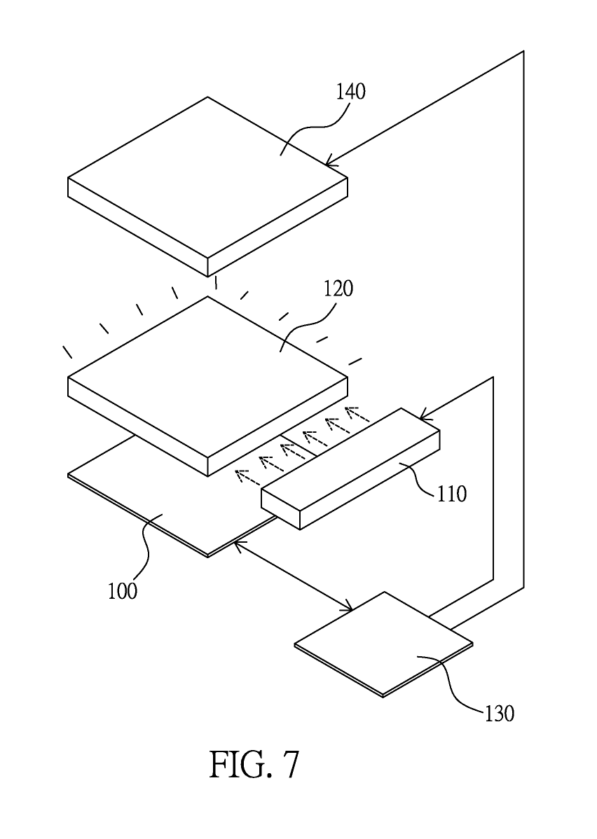

Please refer to FIG. 7, which illustrates an exploded view of a light guide device having touch function according to another preferred embodiment of the present invention. As illustrated in FIG. 7, the light guide device having touch function includes a reflective plate 100, a light source unit 110, a light guide plate 120, a control circuit 130, and a liquid crystal layer 140.

The reflective plate 100 has one or more conductive areas, which can be implemented by aluminum, stainless steel, PET coated with a conductive glue, etc.

The light source unit 110 can include at least one LED and has a light output side.

The light guide plate 120 is located above the reflective plate 100 and has a light input side and a light output face, wherein the light input side is adjacent to the light output side of the light source unit 110, and the light output face is used to output light.

The control circuit 130 includes a light source driver circuit, a touch detection unit, a display driver unit, and a microprocessor (not shown in the figure), wherein, the light source driver circuit is coupled electrically with the light source unit 110 for driving the light source unit 110; the touch detection unit is coupled with the one or more conductive areas of the reflective plate 100 for detecting a touch event on the light output face by performing a capacitive touch detection procedure, which is selected from a group consisting of a self-capacitive touch detection procedure and a mutual-capacitive touch detection procedure; the display driver unit is used to drive the liquid crystal layer 140; and the microprocessor is coupled with the light source driver circuit, the touch detection unit, and the display driver unit for outputting a control signal to the light source driver circuit to control a light emitting status of the light source unit 110 in response to a touch detection result from the touch detection unit.

The liquid crystal layer 140 is located above the light guide plate 120 for displaying an image and providing a touch surface, and can be a TN (twisted nematic) liquid crystal layer, an STN (super twisted nematic) liquid crystal layer, a cholesterol liquid crystal layer, etc.

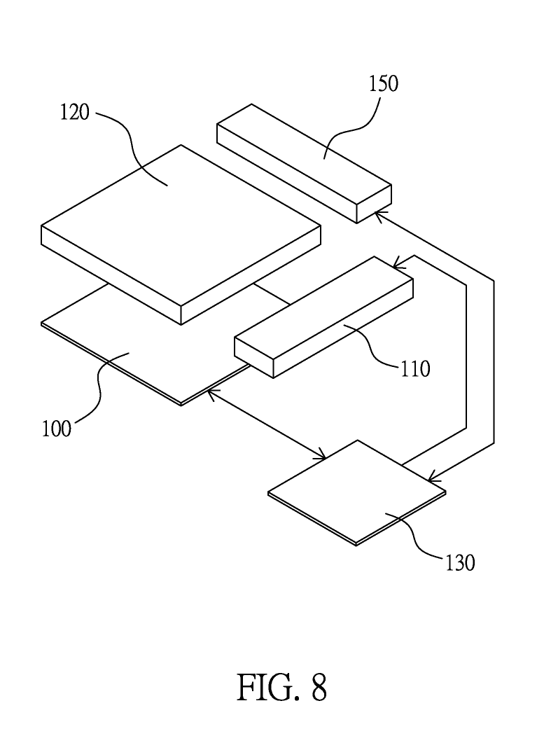

Please refer to FIG. 8, which illustrates an exploded view of a light guide device having touch function according to another preferred embodiment of the present invention. As illustrated in FIG. 8, the light guide device having touch function includes a reflective plate 100, a light source unit 110, a light guide plate 120, a control circuit 130, and a photo sensing unit 150.

The reflective plate 100 has one or more conductive areas, which can be implemented by aluminum, stainless steel, PET coated with a conductive glue, etc.

The light source unit 110 can include at least one LED and has a light output side.

The light guide plate 120 is located above the reflective plate 100 and has a light input side and a light output face, wherein the light input side is adjacent to the light output side of the light source unit 110, and the light output face is used to output light.

The control circuit 130 includes a light source driver circuit, a touch detection unit, a photo sensing circuit, and a microprocessor (not shown in the figure), wherein, the light source driver circuit is coupled electrically with the light source unit 110 for driving the light source unit 110; the touch detection unit is coupled with the one or more conductive areas of the reflective plate 100 for detecting a touch event on the light output face by performing a capacitive touch detection procedure, which is selected from a group consisting of a self-capacitive touch detection procedure and a mutual-capacitive touch detection procedure; the photo sensing circuit is used to receive an output signal from the photo sensing unit 150; and the microprocessor is coupled with the light source driver circuit, the touch detection unit, and the photo sensing circuit for outputting a control signal to the light source driver circuit to control a light emitting status of the light source unit 110 in response to the output signal from the photo sensing unit 150 and/or a touch detection result from the touch detection unit.

The photo sensing unit 150 is used to sense the intensity of ambient light or receive an infrared remote control signal for providing an additional control mechanism.

In addition, by forming a plurality of slots in the light guide plate 120, the light output face of the light guide plate 120 can be divided into a plurality of light output zones.

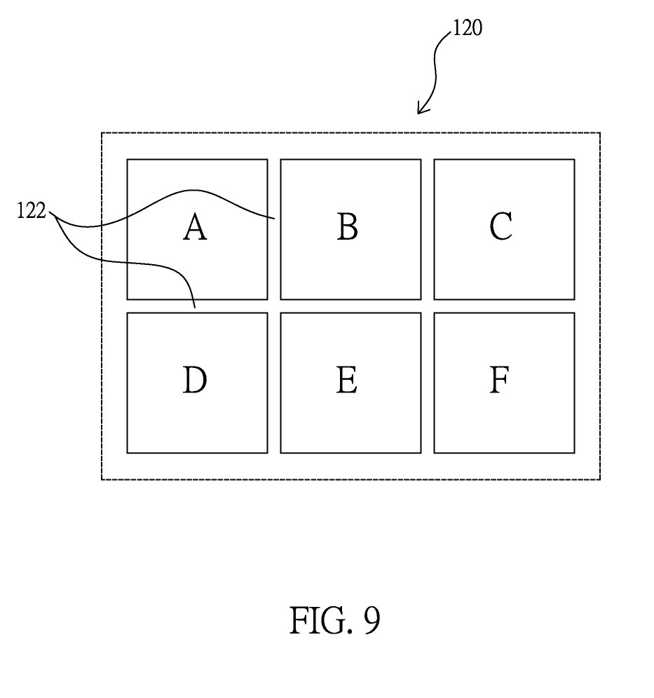

Please refer to FIG. 9, which is an illustrative view of an embodiment of the light guide plate of the light guide device having touch function of the present invention. As illustrated in FIG. 9, the light guide plate 120 is of a rectangular shape and has six light output zones A, B, C, D, E, F divided by a plurality of slots 122. With this arrangement, each of the six light output zones can provide a different color of light.

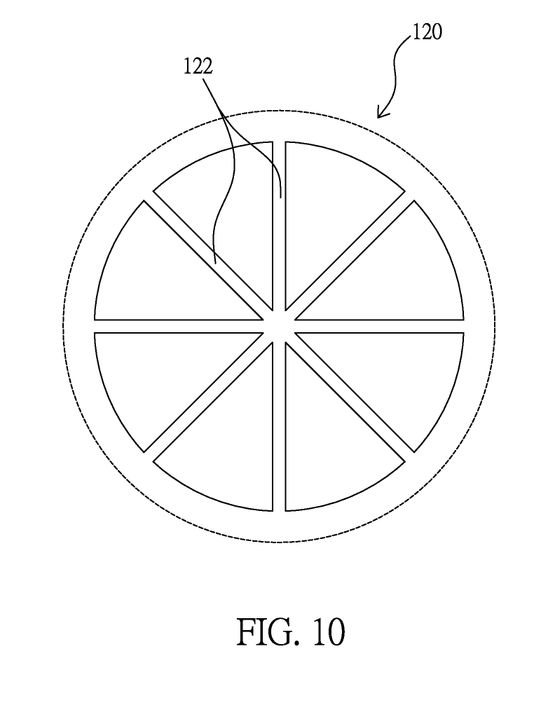

Please refer to FIG. 10, which is an illustrative view of another embodiment of the light guide plate of the light guide device having touch function of the present invention. As illustrated in FIG. 10, the light guide plate 120 is of a disk shape and has eight light output zones A, B, C, D, E, F, G, H divided by a plurality of slots 122. With this arrangement, each of the eight light output zones can provide a different color of light.

Thanks to the proposed designs, the present invention possesses the following advantages:
1. The touch-operable light source device of the present invention is capable of providing a touch-operable light source by utilizing a light guide structure.
2. The touch-operable light source device of the present invention is capable of directly using a surface of a light guide structure as a touch surface, without the need of using an additional touch module.
3. The touch-operable light source device of the present invention is capable of providing separate touch-operable light sources in separate regions of a light guide structure respectively.
4. The touch-operable light source device of the present invention is capable of providing separate touch-operable light sources in separate regions of predetermined shapes of a light guide structure respectively.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A light guide device having touch function, comprising:
a reflective plate having one or more conductive areas;
a light source unit having a light output side;
a light guide plate, located above said reflective plate and having a light input side and a light output face, wherein said light input side is adjacent to said light output side of said light source unit; and
a control circuit having a touch detection unit, wherein, said touch detection unit is coupled with said one or more conductive areas of said reflective plate for detecting a touch event on said light output face.

2. The light guide device having touch function as disclosed in claim 1, wherein said control circuit further includes a light source driver circuit coupled with said light source unit.

3. The light guide device having touch function as disclosed in claim 2, wherein said control circuit further includes a microprocessor coupled with said light source driver circuit and said touch detection unit for outputting a control signal to said light source driver circuit to control a light emitting status of said light source unit in response to a touch detection result from said touch detection unit.

4. The light guide device having touch function as disclosed in claim 1, wherein said touch detection unit detects said touch event by performing a capacitive touch detection procedure selected from a group consisting of a self-capacitive touch detection procedure and a mutual-capacitive touch detection procedure.

5. The light guide device having touch function as disclosed in claim 1, wherein said light output face of said light guide plate has an embossed figure.

6. The light guide device having touch function as disclosed in claim 1, further including a liquid crystal layer above said light guide plate.

7. The light guide device having touch function as disclosed in claim 1, further including a photo sensing unit.

8. A light guide device having touch function, comprising:
a reflective plate having one or more conductive areas;
a first light source unit having a first color of light and a first light output side;
a second light source unit having a second color of light and a second light output side;
a light guide plate, located above said reflective plate and having a first light input side, a second light input side, and a light output face, wherein said first light input side is adjacent to said first light output side of said first light source unit and said second light input side is adjacent to said second light output side of said second light source unit; and
a control circuit having a touch detection unit, wherein, said touch detection unit is coupled with said one or more conductive areas of said reflective plate for detecting a touch event on said light output face.

9. The light guide device having touch function as disclosed in claim 8, wherein said control circuit further includes a light source driver circuit and a microprocessor, said light source driver circuit being coupled with said first light source unit and said second light source unit, and said microprocessor being coupled with said light source driver circuit and said touch detection unit for outputting a control signal to said light source driver circuit to control a light emitting status of said first light source unit and/or a light emitting status of said second light source unit in response to a touch detection result from said touch detection unit.

10. A light guide device having touch function, comprising:
a plurality of reflective plates, each having one or more conductive areas;
a plurality of light source units, each corresponding to one of said plurality of reflective plates and having a light output side;
a light guide plate, located above said plurality of reflective plates and having a plurality of light input zones and a light output face, wherein each of said plurality of light input zones is adjacent to said light output side of one of said plurality of light source units; and
a touch detection unit coupled with said one or more conductive areas of said plurality of reflective plates for detecting a location of a touch event on said light output face.

11. The light guide device having touch function as disclosed in claim 10, wherein said light guide plate has a disk shape.

12. The light guide device having touch function as disclosed in claim 10, wherein said light guide plate further has a plurality of slots dividing said light output face into a plurality of light output zones.
